(19) United States
(12) Patent Application Publication
(10) Pub. No.: US 2005/0201222 A1
(43) Pub. Date: Sep. 15, 2005

(54) Driving method of flexible recording disc

(75) Inventors: Hiroyuki Awano, Ibaraki (JP); Norio Ota, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 11/010,418

(22) Filed: Dec. 14, 2004

(30) Foreign Application Priority Data
Dec. 15, 2003 (JP) 2003-416227

(51) Int. Cl. G11B 7/00; G11B 5/09

(52) U.S. Cl. 369/44.26; 369/47.38

(57) ABSTRACT

An object of the invention is to provide an extremely large capacity disc cartridge which can avoid a head crush and a disc crush and has a high reliability, and a recording and reproducing apparatus for the same. In the invention, there is employed a disc driving method of recording and reproducing a disc substrate (a flexible recording disc) having a low rigidity on the basis of a non-contact mode while rotating at a high speed, having a step of rotating a standstill disc, a step of moving sliders (rotation stabilizing plates) for inhibiting a surface vibration (a vertical vibration) close to both surfaces of the disc from both sides of the disc by using an air flow, at a time when a rotating speed is increased and the surface vibration of the disc is reduced, a step of controlling the rotating speed to a predetermined rotating speed for recording and reproducing after stabilizing the surface vibration so as to record and reproduce, a step of returning the rotating speed to the rotating speed at a time of moving the rotation stabilizing plates close to the disc after finishing the recording and reproducing, a step of moving the stabilizing plates from the disc surface, and a step of stopping the rotation.

### BACKGROUND OF THE INVENTION

1. Field of the Invention

The present invention relates to an information recording system which can store a lot of information, and more particularly to an information recording system in which a plurality of discs are received within one cartridge.

2. Description of the Related Art

An information society has progressed and a packing density of an external memory device for storing an enormous information has been significantly improved. In a magnetic recording, there has been executed research and development for achieving a high density by changing a system from a conventional in-plane magnetic recording mode to a vertical magnetic recording technique, and in an optical disc, there has been executed research and development for achieving a short wavelength of a light source and a high numerical aperture (NA) of an objective lens by using a blue laser. As a technical current for achieving a higher density, a pattern media and a heat assist magnetic recording are proposed in the magnetic recording, and a hologram memory is proposed in the optical disc. However, these techniques require absolutely new recording membrane and drive technique, do not exist on an extension of the current technique, require a lot of development and investment for developing them, and lack a continuity with the current product. On the other hand, there has been considered a method of increasing a number of discs received within a cartridge by reducing a thickness of a disc substrate employed for the current magnetic recording and optical recording. In the magnetic disc and the optical disc, there has already existed a structure in which a plurality of discs are received, however, since a very high rigid substrate is utilized, the number of the discs which can be received within the cartridge is limited. In order to employ a substrate having a low rigidity such as a floppy disc, it is necessary to record and reproduce a disc while restricting a vertical vibration of the dist at a time of rotating by means of a contact or floating type stabilizer, such as the floppy disc and an apparatus described in JP-A-2001-35008 (patent document 1).

However, there has been generated a problem such as a head crush or a disc crush during a process of receiving a plurality of very thin substrates in the cartridge so as to record and reproduce.

### BRIEF SUMMARY OF THE INVENTION

The present invention is made in order to solve the problem in the prior art mentioned above, and an object of the present invention is to provide an extremely large capacity disc cartridge which can avoid a head crush and a disc crush and has a high reliability, and a recording and reproducing apparatus for the same.

In order to achieve the object mentioned above, as in the present invention, it is preferable to employ a disc driving method of recording and reproducing a disc substrate (a flexible recording disc) having a low rigidity on the basis of a non-contact mode while rotating at a high speed, there are employed series of steps comprising a step of rotating a standstill disc, a step of moving sliders (rotation stabilizing plates) for inhibiting a surface vibration (a vertical vibration) close to both surfaces of the disc from both sides of the disc by using an air flow, at a time when a rotating speed is increased and the surface vibration of the disc is reduced, a step of controlling the rotating speed to a predetermined rotating speed for recording and reproducing after stabilizing the surface vibration so as to record and reproduce, a step of returning the rotating speed to the rotating speed at a time of moving the rotation stabilizing plates close to the disc after finishing the recording and reproducing, a step of moving the stabilizing plates from the disc surface, and a step of stopping the rotation.

In the case of getting a lot of flexible recording discs in one disc cartridge and recording and reproducing any discs in turn, an amount of surface vibration which can be restricted by the rotation stabilizing plates is variously changed due to a finite individual difference existing in a plurality of discs. In order to avoid this matter, there are two methods comprising a method of enlarging an air flow design margin by contriving an area and a shape of the rotation stabilizing plate, and a method of driving a flexible recording disc by feedback controlling (focus servo controlling) a propellant fouling which can not be inhibited in the surface vibration by the rotation stabilizing plate in accordance with the present invention so as to avoid a collision between the disc and the recording and reproducing head, by using a light in the recording and reproducing head. In the latter case, it is necessary to make a dynamic range of the focus servo as is different from the conventional optical disc.

Further, in the case that a plurality of flexible recording discs are got in the cartridge and the optional disc is recorded and reproduced, there is generated a problem such as generation of static electricity and generation of dusts in accordance with taking the disc in and out. In the case that the substrate is thick and heavy such as a conventional CD changer type reproducing apparatus, since trays for moving the disc are thick, and a rail within the cartridge to which the trays are fitted is thick and firm, the static electricity and the dusts tend to be generated, and a problem is generated in view of reliability. However, in accordance with the present invention, since the flexible recording disc is thin and light, it is possible to very effectively cope with the generation of static electricity and the generation of dusts by making the tray or a receiving bag for receiving the discs thin and light, and employing a material such as a liner, a clean paper or the like having an antistatic treatment and having a reduced dust generation. Accordingly, it is possible to avoid such an accident that the rotation stabilizing plate nips the charged dusts and such a problem that the dusts are attached to the recording and reproducing head so as to deteriorate a recording and reproducing performance, whereby it is possible to obtain a system having a high reliability. Further, in the case of utilizing the disc receiving bag, in the case that a disc output port is provided in one surface, there is a high possibility that the disc and the receiving bag are rubbed so as to be charged by a static electricity. Therefore, it is desirable to utilize the disc receiving bag having an opening port in which the disc output port is provided in two or more surfaces so as to greatly reduce an amount of friction.

Further, in the case that a whole of the disc receiving bag is taken in and out from the cartridge by using the disc receiving bag, as in the present invention, it is preferable to vertically arrange the cartridge for the purpose of minimizing a frictional force between the adjacent disc receiving bags.

Further, as in the present invention, as a method of taking out the disc from the disc receiving bag, it is possible to avoid a friction between the disc receiving bag and the disc by utilizing a mechanism of opening the disc receiving bag so as to take out the disc. In the case of returning the disc to the cartridge, a maximum effect for inhibiting the dusts and the static electricity from being generated can be achieved in the same manner by inversely executing the series of operations.

On the assumption that a thickness of the flexible recording disc is t1, a thickness of the disc receiving bag is t2, a number of the discs is N, and a thickness of the disc cartridge at a time of taking out the disc or receiving the disc is t, the more the number of the discs which can be received within the cartridge is, the more the data capacity is increased. A thickness of a simple disc bundle in the case of receiving N number of discs can be described by an expression (t1+2×t2)×N. However, an overstock causes an error in a case of taking out any discs and a scratch formed on a data surface. Accordingly, in the case that a hundred sheets of 100 micron substrates are get in a 50 micron disc receiving bag so as to be overlapped, and are received in a cartridge having a thickness of 25.4 mm, one disc can be just taken out without being greatly rubbed. A sum of the thickness of the receiving bag and the total thickness of the discs is 20 mm on the basis of a simple calculation. About twenty % extra exists in comparison with the cartridge thickness 25.4 mm. On the basis of this result, it is desirable that a limit of an extra receiving satisfies a relational expression (t1+2×t2)×N×1.2<t. Further, it is possible to achieve a largest capacity by using the disc operating method having the relation between the cartridge and the disc.

Next, a description will be given of a method of taking out an optional disc from the cartridge receiving a plurality of discs. There can be considered a method of taking out an Nth disc by an apparatus such as a paper money counter in a state in which a plurality of discs are directly overlapped. Since the surface of the optical disc is scratched in this method, it is preferable to utilize the disc tray or the disc receiving bag. In this case, a method of file managing what data is recorded in a disc is important, and this method includes a method of providing with a memory in each of the discs and taking up the data from one by one so as to manage the data, however, it is not preferable to execute this method every time when the cartridge is replaced. Accordingly, if a memory is provided in the cartridge and all the disc file information is stored in the memory, it is possible to immediately know what disc within the cartridge is taken out. However, it is hard to search a desired disc from the cartridge, and if the cartridge drops down and the memory is broken, it is necessary to again absorb all the information from all the discs. In the case that the memory is installed in each of the trays or the disc receiving bags as in the present invention, it is possible to immediately have access to the necessary disc by searching the memory.

In this case, even if the cartridge drops down and the cartridge cracks, an impact is hard to be transmitted to the disc in the cartridge, so that there is obtained an advantage that the file information is hard to be broken. Further, in this case, it is easy to take out the necessary disc from a plurality of cartridges so as to form a new cartridge. However, if the contents throw off and the discs and the trays or the receiving bags are scattered, it is necessary to search a corresponding relation between the discs and the trays or the receiving bags.

In order to achieve a further easy operation, the memory is added to the cartridge in accordance with the present invention. This structure is convenient at a time of searching the cartridge.

Next, a description will be given of a method of taking out the disc. It is preferable to make an operating portion of the disc tray or the disc receiving bag locally thick as in the present invention so as to easily pick out the disc by a robot. In this case, it is possible to embed the memory or attach the memory.

In the case that the structure is made such that the position of the operating portion of the disc tray or the disc receiving bag which is locally thick as in the present invention does not lap over the adjacent receiving portion, it is possible to receive a maximum number of discs within the cartridge.

Since the flexible recording disc is very thin, a chucking portion for the thin disc is scratched in the case that concavity and convexity exists in the disc chucking portion such as a digital versatile disc (DVD). Accordingly, it is possible to reduce a damage applied to a center of the thin substrate by using a chucking jig or a flat chucking having no concavity and convexity in a chucking receive portion.

The above description relates to the method using the rotation stabilizing plate. In addition to this, the turn table and the flexible disc are closely contacted by loading the flexible recording disc on the turn table and rotating at a high speed, whereby the surface vibration is inhibited. The recording and reproducing can be executed by actuating the recording and reproducing head in this state.

In order to speed up the data transfer, there can be executed three kinds of parallel transfers comprising a parallel transfer utilizing both surfaces (surface A and surface B) of the disc, a parallel transfer independently provided with recording and reproducing heads for land and group in the surface A, and a parallel transfer of parallel transferring a plurality of drives. The plural drive parallel transfer is general, however, in the flexible recording disc in accordance with the present invention, since the both surface parallel transfer and the land and group parallel transfer can move the head close to the disc at a time of utilizing the rotation stabilizing plate, it can be considered that these parallel transfers are compatible. In particular, since a phase difference is different between the heads for the land and the group, the heads which are independently adjusted are required, so that it is possible to arrange the heads in conformity to the rotation stabilizing plate.

In accordance with the present invention, it is possible to avoid the head crush and the disc crush on the basis of the means mentioned above, and it is possible to provide the extremely large capacity disc cartridge having a high reliability, and the recording and reproducing apparatus for the same. This structure corresponds to a so-called mini-library. The conventional type library apparatus has been in a large scale and required a great placing volume, and has been accordingly expensive. However, in accordance with the present invention, it is possible to provide the library apparatus in a small scale and at a low cost.

### BRIEF DESCRIPTION OF THE SEVERAL VIEWS OF THE DRAWINGS

FIGS. 1A to 1C are flow charts for explaining a driving method for recording and reproducing a disc cartridge and a recording disc in accordance with the present invention;

FIGS. 2A to 2E are schematic views for explaining a disc transfer mechanism and a disc take-out and receive assisting mechanism in accordance with the present invention;

FIG. 3 is a view for explaining a structure at a time of disc chucking, in accordance with the present invention;

FIGS. 4A to 4E are views for explaining a conveyance of a thin type disc, in accordance with an embodiment 2 of the present invention;

FIGS. 5A and 5B are views for explaining a sag of the thin type disc;

FIG. 6 is a view for explaining one example of a method for reducing an amount of disc surface vibration at a time of rotating the thin type disc at a high speed;

FIGS. 7A and 7B are views showing a structure of a disc rotation stabilizing plate in accordance with the present invention, which solves a problem on the basis of the method shown in FIG. 6;

FIGS. 8A and 8B are views showing the other structure of the disc rotation stabilizing plate in accordance with the present invention, which solves the problem on the basis of the method shown in FIG. 6;

FIG. 9 is a view showing results obtained by measuring the amount of disc surface vibration in the case that the disc rotation stabilizing plate shown in FIGS. 7A and 7B is provided and the case that it is not provided;

FIGS. 10A and 10B are views showing a state in which a thin type optical disc is inserted to a cartridge, in which FIG. 10A shows a side elevational cross sectional view and FIG. 10B shows a plan view; and

FIGS. 11A and 11B are views showing a state in which a disc receiving bag is opened and a disc is taken out from the disc receiving bag.

### DESCRIPTION OF THE PREFERRED EMBODIMENTS

### Embodiment 1

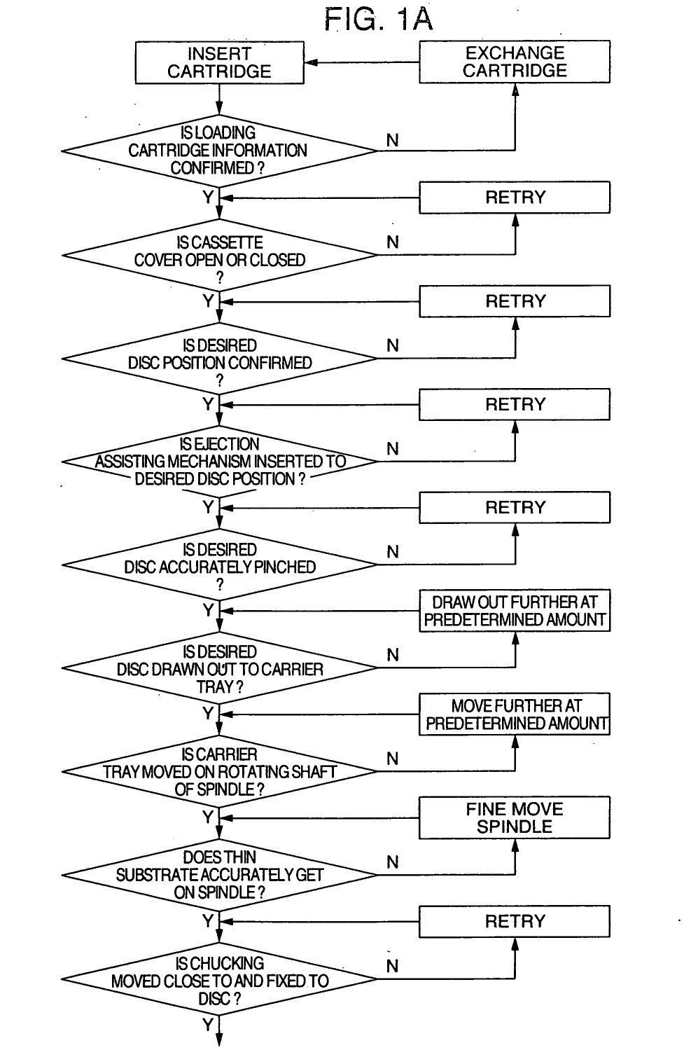

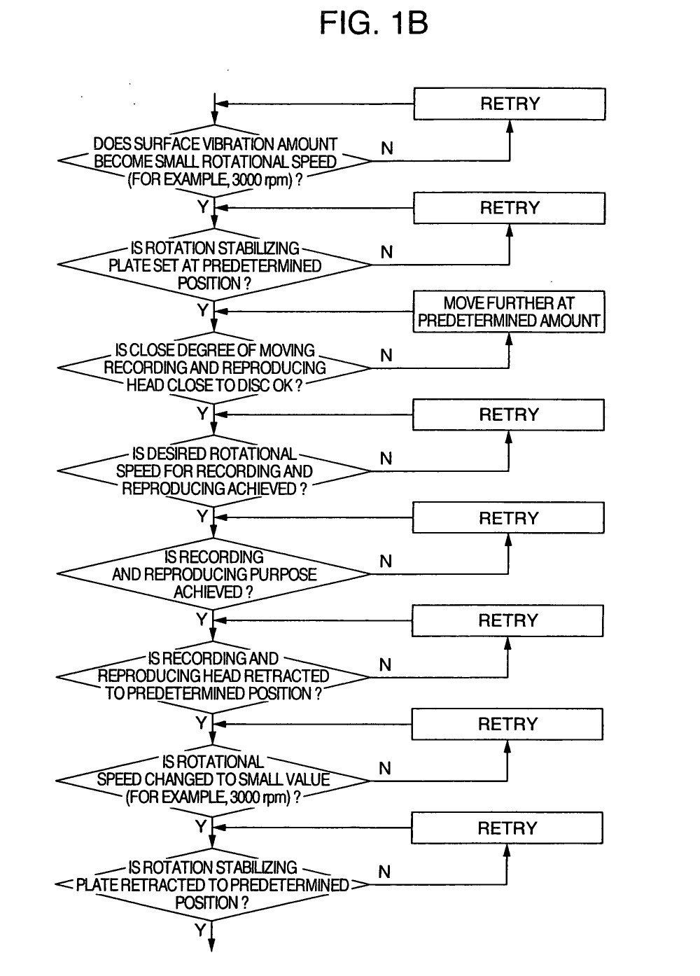

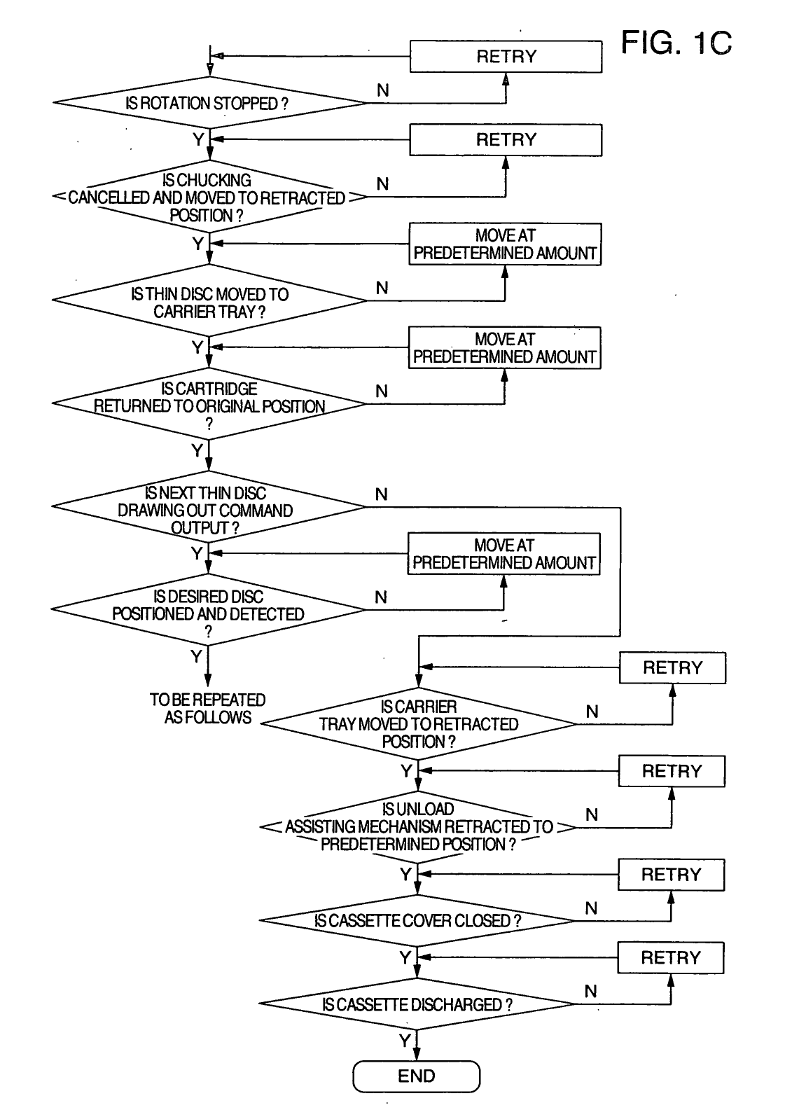

As a means for solving the problem mentioned above, there are a case that a disc cartridge is removable and a case that the disc cartridge is rigid. A description will be given here of the removable type. FIG. 1 is a flow chart arranging these steps.

The steps mount a disc which is bent due to a low rigidity on a tray for taking in and out of a cartridge, take out a desired disc by a detecting and taking out mechanism for selecting an optional disc, are provided with a come-off preventing apparatus so as to prevent the disc from coming off at a time of moving, are provided with a sensor for detecting an optimum position with regard to setting to a spindle, have a method of fixing the disc to the spindle without damaging a chucking portion of a thin substrate, are provided with a control part for moving a recording and reproducing head close to the disc by utilizing a mechanism for putting the bending of the disc right, retract the recording and reproducing head and a rotation stabilizing plate after finishing the recording and reproducing, again move the disc to the tray so as to receive the disc in a cartridge empty space, select the next input and instructed disc, and again execute these series of operations.

A description will be listed up key points necessary for executing the series of operations mentioned above. First, a description will be given of a method of preparing the disc. There can be considered that the disc is prepared by utilizing a flexible material, for example, a polycarbonate sheet, a polyimide sheet, a PET sheet and a PEN sheet. In this case, a surface roughness of a disc surface equal to or less than 0.5 nm is preferable in a magnetic recording or an optical recording. This can be achieved by applying a physical and chemical etching method to a surface of a substrate. Further, it is desirable that a surface roughness in the case that a flat substrate is used in the magnetic recording is half of the surface roughness mentioned above. In this case, it is possible to widely improve a track density by applying a heating and pressurizing treatment of a stamper having a narrow track servo pattern formed therein as mentioned below to the thin substrate so as to nano-print. In this case, since the thin substrate surface can be smoothened in accordance with the heating and pressurizing treatment, the surface roughness of the sheet itself may be comparatively rough in this case. In the case of the optical disc, since a nano-print process of forming a guide groove is applied, no great limitation is generated in the surface roughness of the sheet if an effect thereof is sufficient, whereby it is possible to utilize an inexpensive sheet. In the case of the optical disc, it is necessary to restrict a retardation low if the light is irradiated through the substrate.

The nano-print technique mentioned above means a method of heating the flexible sheet to a desired temperature and pressing a stainless plate having a smooth surface thereon by a pressing machine. In addition, there can be considered a method of forming a discrete track and a servo pattern of a pattern media for a magnetic recording by a stamper which can execute a heat and press molding. In the same manner, in the case of the optical disc, an optical disc pattern can be formed by using a stamper which can execute and press molding and in which the tracking pattern and an address are formed. In particular, in the case that a depth of a formed groove is shallow, it is comparatively easily form the pattern. The pattern formation can be comparatively easily executed in the case of being formed on one surface, however, can be simultaneously executed on both the surfaces. In other words, the step prepares two stampers in which the patterns formed at the same position on both the surfaces of the sheet are set in a mirror relation, sets both the stampers in a heating stage after adjusting such that disc centers of both the stampers are aligned, and press heats and molds at a pressure of about 10 ton after heating both the stampers and the base material to a desired temperature at a desired position. It is possible to reduce a residual stress remaining in both the surfaces of the sheet to the minimum by simultaneously processing both the surfaces as mentioned above.

As a method of forming the thin substrate manufactured in the manner mentioned above in a thin disc shape, there is a method of punching process by a pressing machine, however, a timing of the punching process has the following two kinds. (1) a punching process before forming a recording membrane, and (2) a punching process after forming the recording membrane and a protecting membrane in a sheet. In the case (1), the punched disc-shaped sheet is conveyed by a robot on the basis of a vacuum chucking, and is fed to a recording membrane forming machine, and the protecting membrane is formed in the accomplished disc with the recording membrane. In the case of the both surface disc, the recording membrane surface is reversed and the same recording membrane and protecting membrane are formed on the remaining surface. In the case of holding the disc by an outer periphery, it is possible to simultaneously form the recording membrane and the protecting membrane on both the surfaces. As far as the substrate is accomplished, it is possible to form the thin disc basically in accordance with a conventional style of forming the recording membrane on a thick substrate, in spite of a slight change in a disc conveyance system. In the case (2), since it is possible to form the recording membrane and the protecting membrane in a state of keeping the sheet form, it is possible to expect a possibility that a manufacturing tact time can be widely improved.

When forming the recording membrane and the protecting membrane in the thin substrate, the disc is bent due to a stress generated in an interface thereof. For example, in the case that they are formed only on one surface, a great stress remains only on one surface, so that a great bending is generated in one direction. However, in the case that the recording membrane and the protecting membrane having the same structure are formed on both the surfaces of the extremely thin substrate, the residual stresses on both the surfaces are balanced, so that it is possible to restrict the bending to an extremely small value. It is possible to record on both the surfaces by arranging the recording and reproducing heads in both the surfaces of the thin substrate, and it is preferable to record on both the surfaces for the thin substrate.

In the case of the conventional type of optical disc in which the light is irradiated from the side of the thin substrate, it is of course desirable that the substrate is transparent with respect to the laser beam. In this case, since the recording membrane is formed only on one surface, there is a tendency that the disc bending is significantly increased. However, it is possible to put this bending right by controlling a condition for forming the protecting membrane on the light incident surface. There is a risk that the shape of the thin disc is changed due to a temperature and humidity change. However, in the case that the front surface and the back surface are formed absolutely symmetrically as mentioned above, the pressure balance does not collapse even if the temperature and humidity change is generated, so that it is possible to safely utilize the disc.

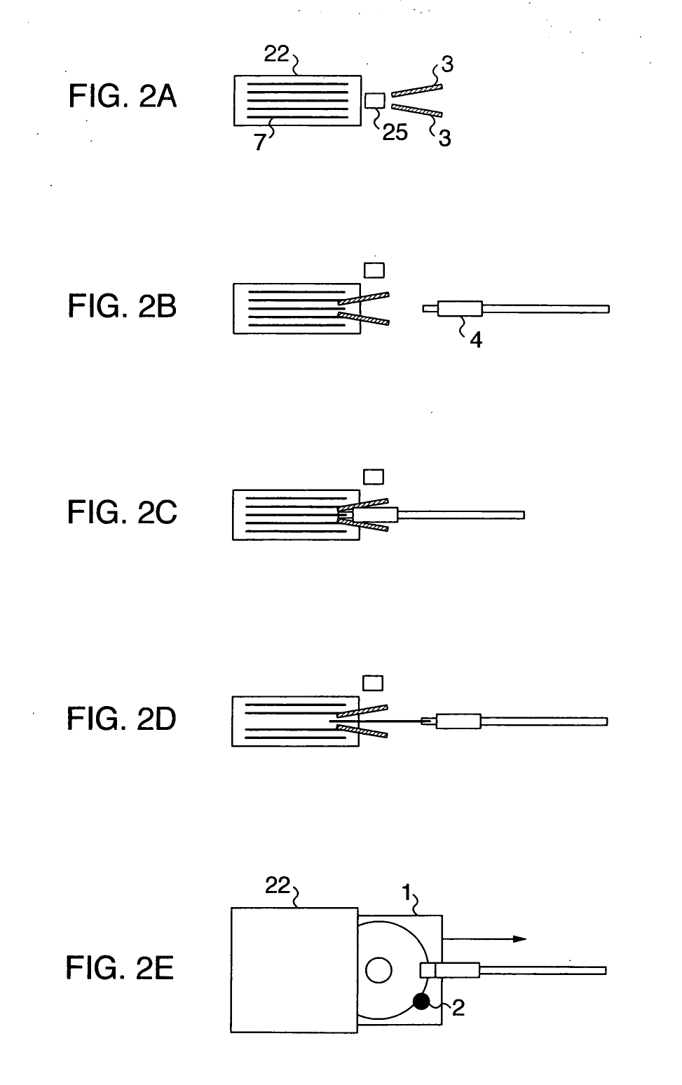

When a plurality of thin discs are received within one cartridge, it is possible to have access to an optional disc and disc address only by loading the cartridge, thereafter moving all the discs to the recording and reproducing apparatus one by one and reading the disc management information of all the discs. Since this is a crucial matter in view of a data management efficient, it is preferable to record the disc information and the disc file information in an external memory attached to the surface of the cartridge. A volume of memory data is determined on the basis of a number of the discs and a number of the files, and it is necessary to update the data at the same time of an end of the file access. Further, in order to select an optional disc within the cartridge, it is necessary that the disc positional information is described in the memory mentioned above. It is possible to detect the position of the disc by installing a tag chip such as FRID or the like in the disc or attaching the tag chip to the disc, however, the sensor should be set to a position near the tag chip. A simplest method is a method of attaching the tag chip to the disc tray, and it is necessary to input the information of the disc loaded on the thin tray to the tag. In this case, it is preferable that the position sensor is arranged in the side of the cartridge and the IC tag is set in the side of the tray. Further, in addition to the tray type, there is a method of forming a partition plate within the cassette by a structure obtained by coating an aluminum on a thin film such as a nylon or the like or an aluminum foil and receiving the thin disc on the partition plate. It is preferable to use a carrier tray 1 shown in FIG. 2 for carrying them.

Next, with regard to the matter that the thin discs are received in the cartridge, a best receiving efficiency can be achieved by receiving the discs in a state of simply overlapping the discs. For example, in the case that the thin discs having a thickness of 100 micron are received in the cartridge having an inside dimension of 20 mm, two hundreds of discs can be received. In the case that the volume of one surface of one disc is 25 GB, the volume of 50 GB is obtained by both the surfaces, and the volume of 10 TB is obtained by two hundreds of discs. In this case, it is necessary to make the protecting film tough so as to prevent the discs from being grazed and generating an error. Further, in the case that the cartridge is vertically placed, no load of the other discs is applied, and one desired disc is easily taken out independently. In order to make it easier to take out the disc, it is preferable that the cartridge is opened and a frontage for taking in and out the disc is widened.

In the case of using the disc tray, it is necessary that a tray receiving shelf is provided in the side of the cartridge, and the number of the discs which can be received within the cartridge tends to be limited. In this case, since a possibility at which the discs are grazed is widely reduced, a reliability is largely improved.

Further, in the case that a spacer which is thinner than the thin disc is put between the discs and the discs are received, the disc can be taken in and out by utilizing the thin spacer in place of the tray, so that the cartridge receiving shaft is not necessary in the side surface of the cartridge, and the disc receiving efficiency is increased. Further, in this case, there is obtained the advantage that the discs are not grazed with each other. It is preferable to attach the IC tag in the thin spacer for detecting the disc position, however, since the position of the space is not definitely determined, it is necessary to carefully search the position by a position sensor.

In accordance with an idea for improving the receiving efficiency and avoiding the disc grazing, the disc is received in a bellows-type receiving bag, and the disc can be safely and securely taken in and out by opening the cartridge so as to widen a distance between the bellows-type receiving bags. Further, the disc position detection can be easily executed by attaching the IC tag to the bellows-type receiving bag.

A desired thin disc position detector 25 can utilize an optically detecting method by using a bar code or forming a plurality of characteristic holes in an end of the receiving bag, in addition to the IC tag. Further, a sensor for confirming whether or not the disc is securely received within the receiving bag is required. For example, as shown in FIG. 2E, the structure may be made such that a hole or a recess 2 is formed in a part of the carrier tray 1 and the light is applied to the portion. In this case, if the light is shielded, it is known that the disc remains on the carrier tray 1. On the other hand, since the light is shielded at a time of starting the receiving, it is known that the disc is not moved yet. Further, since the light is not shielded at a time of the end of the receiving, it is possible to recognize that the disc movement is completed.

As mentioned above, when comprehending the optional disc position, it is necessary to move the disc to a spindle motor 26 portion by a disc transfer mechanism 4. Accordingly, it is necessary to securely take out the disc from the cartridge or receive the disc. It is preferable to arrange a disc take-out and receive assisting mechanism 3 as shown in FIG. 2A close to the disc position within the cartridge. It is necessary to confirm the close contact end by an optical or contact or non-contact positioning sensor.

When the installation of the disc transfer assisting mechanism mentioned above is finished, the disc transferring mechanism 4 is moved close to the disc, and the disc is taken out and is loaded on the transferring mechanism, as shown in FIGS. 2B and 2C. At this time, it is necessary that the contact sensor is provided in a chuck portion so as to securely chuck out the disc. A sensor for confirming whether or not the disc is accurately moved to the tray portion is also required. In the case of the thin substrate, there is a high possibility that the disc arbitrarily moves in the tray at a time of transferring the disc so as to generate an error. Accordingly, in order avoid the disc from arbitrarily moving, the tray edge portion requires some device. This device is structured such as to mechanically work with the motion of the tray. When the disc transfer is finished by the tray, the disc is placed in the spindle by moving down the tray, or the rotation center of the spindle is set to the disc center by moving up the spindle.

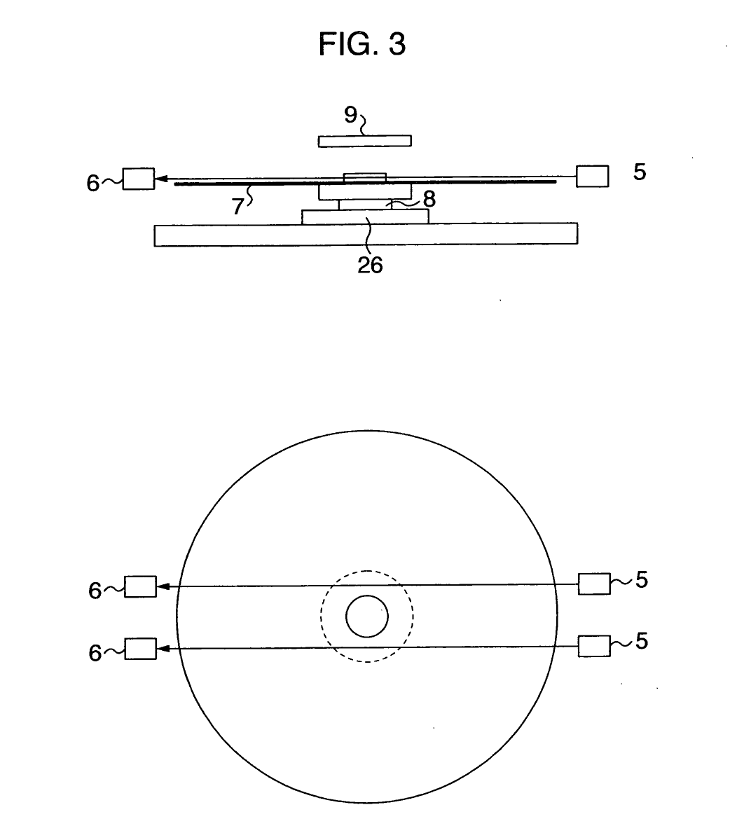

The disc chucking is most important in treating the thin disc. Since the substrate is thin, the chucking at an erroneous position causes a scratch or a recess at an unnecessary position on the disc, and there is a risk that the shape of the hole for eccentrically aligning is deformed. Accordingly, it is preferable to employ a disc contact part utilizing a resin or a rubber having a device for increasing a coefficient of friction in the chucking portion so as to fix to the spindle in accordance with a surface contact. The chucking method may employ any one of a mechanism clamp type and a magnetic clamp type. Further, in general, a cone-like taper is formed in the spindle portion of the CD or the DVD, or a spring type extruding device for fixing the thick substrate without any play is formed therein, however, in the case of the thin disc, a deep straight shape with no play is preferable. If the center hole of the thin disc runs on the rotating shaft of the spindle, the light is shielded in the case of setting the light source 5 and the light detector 6 as shown in FIG. 3, and no light enters into the detector. Accordingly, it is known that the position at which the thin disc 7 is loaded has a problem. On the contrary, in the case that the disc is normally mounted on the spindle, the light enters into the light sensor both at two points, so that it is known that the center hole of the thin disc is normally placed on the spindle rotating shaft 8 without running thereon. In the case that the problem of the disc running on is generated, there can be considered a countermeasure such as moving the spindle slightly, or getting out an arm from the position of the light sensor in the side in which the light can not be detected so as to move the disc slightly and move the arm such that the light is returned to the light sensor. When it is confirmed that the disc is securely mounted on the spindle, a secure chucking is executed by moving a lid 9 for fixing the disc close to the disc from the upper portion. At this time, the recording and reproducing head and a disc rotation stabilizing plate mentioned below are retracted to a retracted position by an equipment for moving them upward and downward at a time of an initial rotation of the disc.

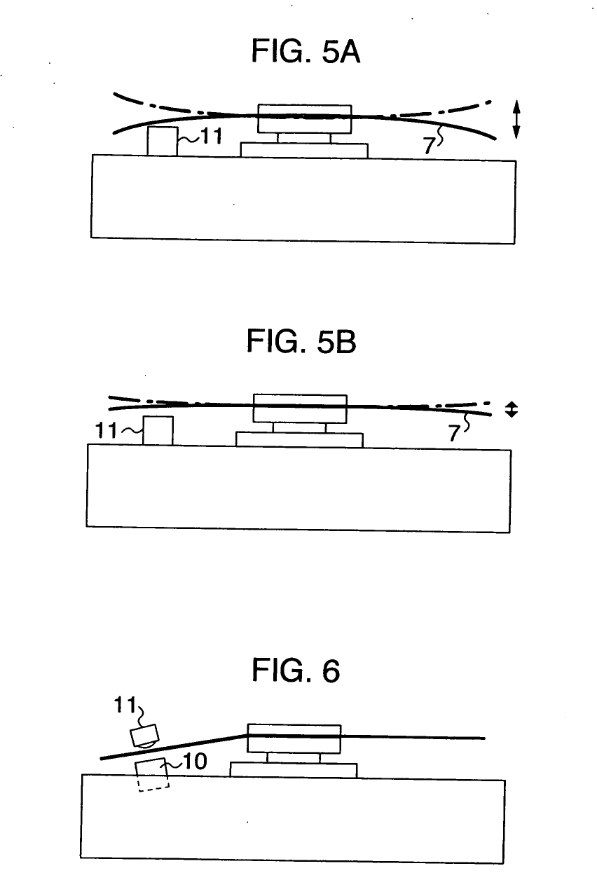

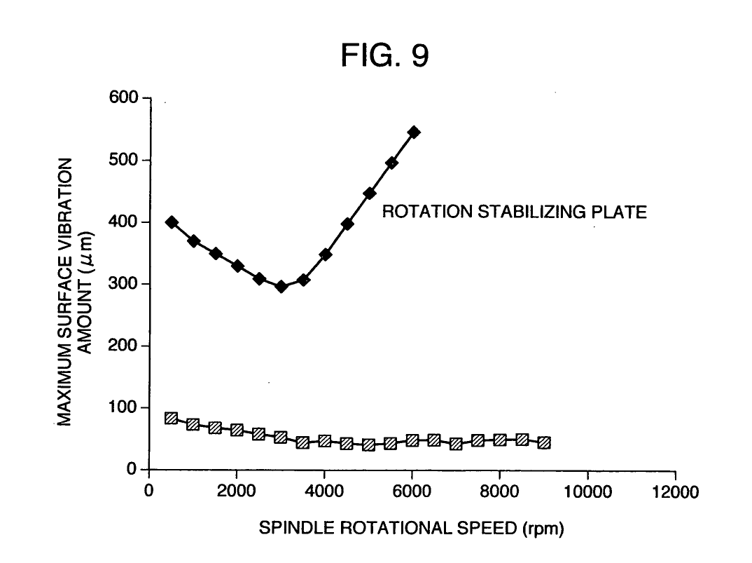

Both sides of the thin optical disc hang downward to right and left sides as shown in FIG. 5A at a time of the stop of the spindle. However, when rotating the spindle at a high speed, the hanging is reduced on the basis of a centrifugal force as shown in FIG. 5B, and an amount of so-called surface vibration that the disc flip-flops upward and downward at a time of the rotation of the disc is widely reduced. However, in this state, the amount of the surface vibration does not reach a recordable and reproducible level yet as shown by a result of experiment of the case having no rotation stabilizing plate shown in FIG. 9. Accordingly, in order to further reduce the amount of the disc surface vibration, a rotation stabilizing plate 10 is moved close to the optical disc as shown in FIGS. 6, 7 and 8. FIG. 6 shows a method of making only one rotation stabilizing plate 10 to oppose to a recording and reproducing head 11. In the case that the rotation stabilizing plate 10 generates a negative pressure, the disc is attracted to the rotation stabilizing plate 10, so that the disc and the rotation stabilizing plate 10 are in a grazed state. Accordingly, a negative pressure rotation stabilizing plate can not be used. Therefore, a positive pressure rotation stabilizing plate is utilized as shown in FIG. 6. However, in accordance with the method shown in FIG. 6, since a positive pressure is applied to the disc only from one side, a shape of the disc is bent so as to form a stable state, and this bent stable state is changed in accordance with a rotating speed. Unless the recording and reproducing head 11 and the disc are controlled so as to be kept in parallel to each other, the focused light is formed in an oval shape and it is hard to record and reproduce. Accordingly, a tilt correcting mechanism is required and this structure is not practical. In this case, if the recording and reproducing head 11 is fixed to a floating type slider, the floating type slider and the disc surface are always in parallel to each other, so that it is possible to achieve a practical application on the basis of this combination. However, since the optical disc largely repeats the bending in correspondence to the rotation in the chucking portion, a material fatigue is repeated on the basis of the repeated bending, so that a problem is generated in view of a reliability.

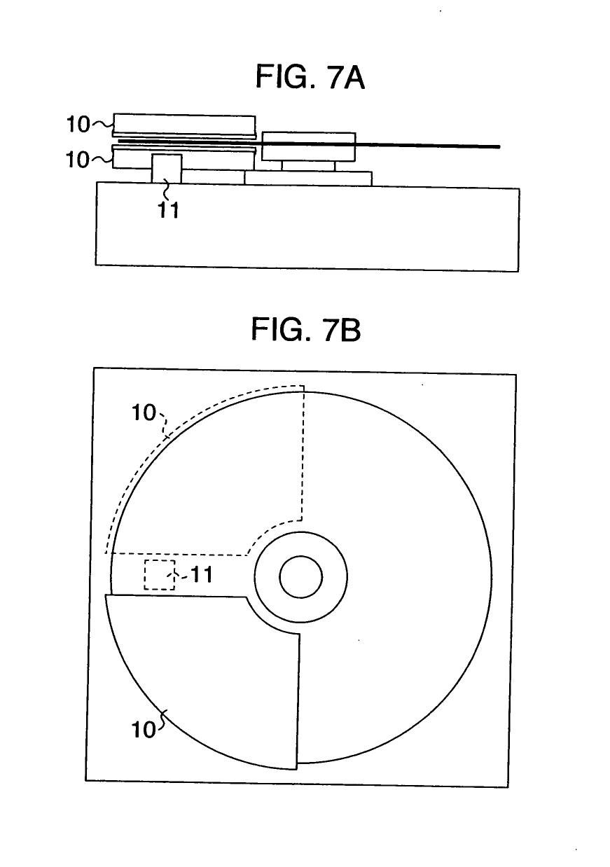

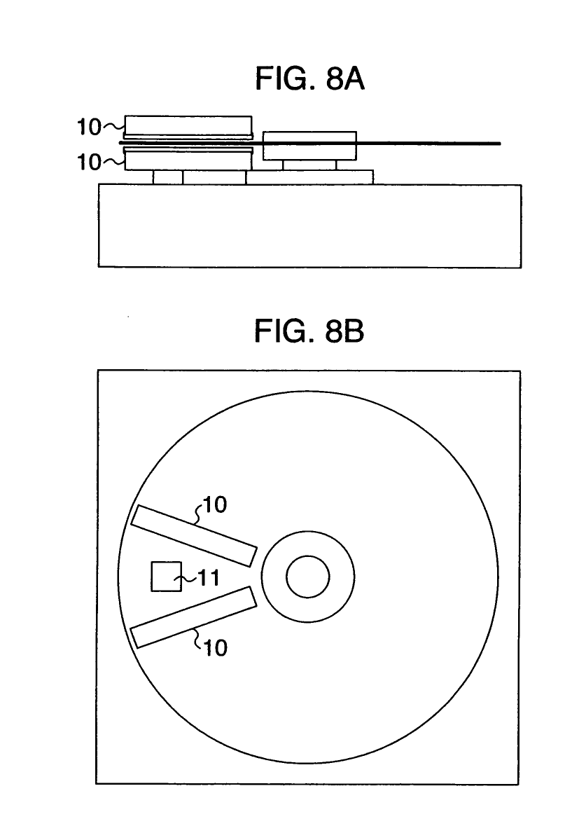

In order to avoid this problem, it is preferable to employ a method of arranging the rotation stabilizing plates 10 having similar shapes in both sides as shown in FIGS. 7 and 8 so as to utilize the disc in a flat state. In accordance with the method shown in FIG. 7, since the same level of negative pressure is generated between the disc in the upper surface and the lower portion of the rotation stabilizing plate in the upper surface, and between the disc in the lower surface and the upper portion of the rotation stabilizing plate in the lower surface, and the attractive forces to each other are balanced, it is possible to achieve a stable floating. It is preferable to arrange the recording and reproducing head 11 in the boundary portion. Further, FIG. 8 shows an example in which two sets of positive pressure rotation stabilizing plates 10 are moved close to the disc from both sides of the recording and reproducing head 11 so as to hold the disc therebetween. The positive pressure generated between the disc and the rotation stabilizing plate 10 is applied in a direction of moving the disc apart from the rotation stabilizing plate 10, however, since the rotation stabilizing plates 10 are opposed to each other with holding the disc therebetween as shown in FIG. 8, the pressing forces are balanced, and a stable rotation is achieved. In the case that two sets of rotation stabilizing plates 10 are arranged in front of and at the back of the recording and reproducing head 11, it is possible to make the recording and reproducing head portion in a stable rotating state. In this case, FIG. 9 shows results of experiments for measuring the amount of the disc surface vibration on the basis of with or without the negative pressure rotation stabilizing plate shown in FIG. 7, and it is known that an excellent stable rotation can be achieved by providing with the rotation stabilizing plates in both sides of the disc. In practice, it is necessary to the minimum to set the amount of the surface vibration to be equal to or less than 100 micron, and it is known that this necessity can be widely cleared by utilizing the rotation stabilizing plate.

In the case that the recording and reproducing head is constituted by a magnetic head, a flying height is some tens nm, and it is necessary to approximately simultaneously move the magnetic heads in both the surfaces of the disc close to the disc while holding the same flying height. Accordingly, it is necessary to install the disc rotation stabilizing plate inhibiting the disc from flip-flopping in both sides of the magnetic head. A procedure of loading the magnetic head after inhibiting the surface vibration as much as possible by this rotation stabilizing plate is important. In order to confirm the effect of the rotation stabilizing plate, it is necessary to measure a displacing and changing amount of the disc and the rotation stabilizing plate by an electrostatic sensor or an optical sensor at a part of the rotation stabilizing plate.

In the case that the recording and reproducing head is constituted by an optical head, a leading end portion is apart from the disc surface at about 1 mm, and it is unnecessary to take thought for the collision with the disc as is different from the magnetic disc. It is important to design so as to set both sides of the disc of the rotation stabilizing plate to a reference surface and avoid the collision of the disc with the head even if the disc is collided with the rotation stabilizing plate. If it is assumed that the disc is collided with the rotation stabilizing plate, a cushioning material such as a softer resin than the disc protecting membrane is arranged at a position of an outer peripheral portion of the disc in the rotation stabilizing plate so as to prevent the data surface from being scratched.

If the spindle rotation is started after the confirmation of the fixing is finished by a spindle fixing sensor of the disc, the surface vibration is generated, however, the surface vibration of the thin disc is reduced at a time point of 3000 rpm. In this case, the rotation stabilizing plate is moved close to the disc from both the surfaces of the disc at about 100 to 300 micron. The rotation stabilizing plate is positioned by preparing a mechanical stopper and moving the stopper close to a stop position. After the optical sensor or the mechanical switch are attached to the stopper and confirm that the rotation stabilizing plate moves to a predetermined position, the rotating speed is slowed down to 1000 rpm, and the recording and reproducing head is moved close to the disc, whereby the recording and reproducing operation is executed. After the recording and reproducing is finished, the recording and reproducing head is retracted, the rotating speed is returned to 3000 rpm, and the rotation stabilizing plate is moved apart from the disc. Thereafter, the rotation is stopped.

In the case that the movement of the recording and reproducing head is executed by a swing arm type structure, the shape of the rotation stabilizing plate is aligned with a locus of the swing arm movement. In order to secure a floating stability of the magnetic head, it is necessary to avoid an eddy flow caused by the end portion of the rotation stabilizing plate. Accordingly, on the assumption that a thickness of the rotation stabilizing plate is set to t, and a distance from the rotation stabilizing plate to the recording and reproducing head is set to T, a relation 2t<T is preferable. In the case that the movement of the recording and reproducing head is linear, the shape of the rotation stabilizing plate is formed in a simple straight type.

In the case that the recording and reproducing head is provided in both the surfaces, on the assumption that one surface is called as a surface A and the remaining surface is called as a surface B, it is possible to independently execute two-channel data transfer on the surface A and the surface B or execute a parallel transfer of finely separating the file on the basis of a desired unit so as to sequentially record and reproduce on the surface A and the surface B alternately. In the former case, in the case that it is necessary to have access to the different positions on the surface A and the surface B, when the recording and reproducing head is necessarily arranged in the opposing positions, it is necessary to have access to a desired address on the surface B after the end of the recording and reproducing on the surface A, so that an efficiency is deteriorated. In this case, it is necessary to prepare two sets of rotation stabilizing plates and recording and reproducing heads and arrange them at positions which are not interfered with each other. In the case that a defect is found on the surface A in accordance with the latter parallel transfer, an alternating process is executed at the different places, so that the data is recorded in a place corresponding thereto in the side of the surface B. Since a utilization of the normal area on the surface B existing in a back side of defect area on the surface A is accordingly abandoned, the efficiency is reduced. Therefore, even in the case of the parallel transfer, the structure which can independently have access to the surface A and the surface B is desirable.

### Embodiment 2

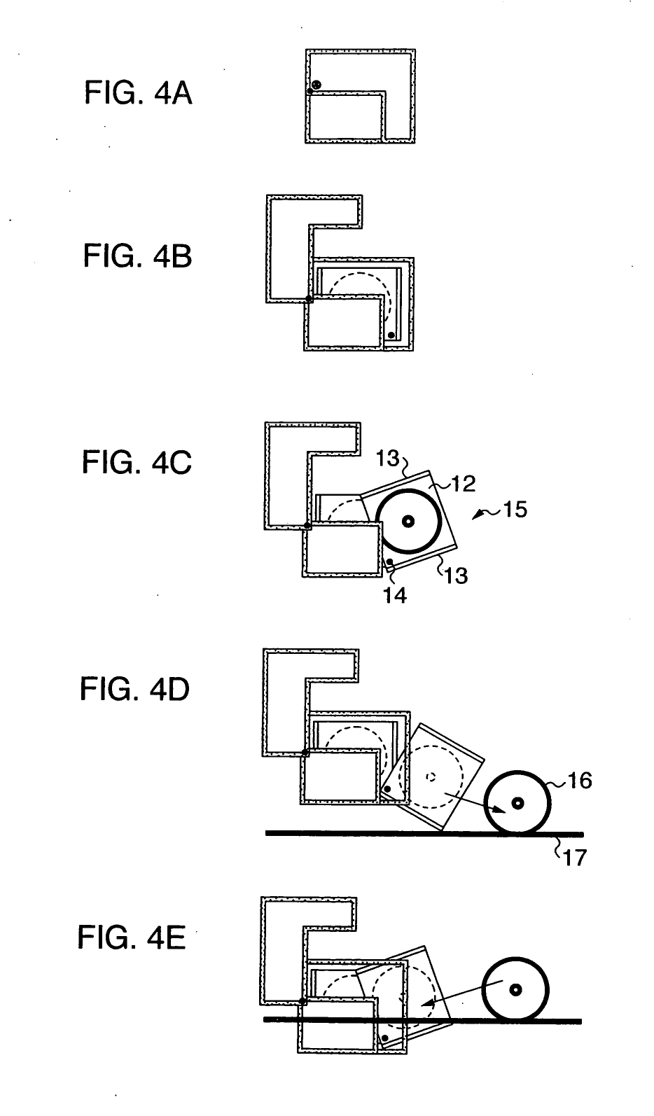

As the most method of carrying the thin disc is constituted by a method of loading the disc on the tray and a method of wrapping the disc by a carrier cover so as to move. In this case, the cartridge is complicated and the carrying method is complicated. However, it is possible to comparatively easily take in and out the thin disc by using a means for carrying the disc by rolling as shown in FIG. 4. In FIG. 4, the structure is made such that the thin disc can be received by overlapping two sheets of thin films 12 which is punched at 135 mm square, is applied an antistatic treatment and has a thickness of 30 micron, and the opposing edges 13 are bonded by applying a heat by means of an extra fine iron heated at 100 degree or more, whereby the thin disc can be received. As shown in FIGS. 4B, 4C and 4D, a through hole 14 is provided in a right corner of the thin disc receiving bag, and a rotation support rod is stuck therethrough from the cartridge, whereby it is possible to rotate only an optional disc receiving bag 15 so as to take out. A thin disc 16 is taken out so as to roll by making an opening portion of the receiving bag to be directed to the right below as shown in FIG. 4C. Accordingly, by preparing two upper and lower narrow guide rails 17 having a size of about some tens micron near an outlet of the receiving bag, it is possible to carry the disc to the portion near the drive. Further, at a time of receiving, it is possible to return the disc to the original receiving bag while rolling by moving upward the rail higher as shown in FIG. 4D. It is possible to easily carry the thin disc by tilting the cartridge or executing a motion of tilting the recording and reproducing apparatus.

### Embodiment 3

In the case that the optical head is arranged in both sides, it is possible to record on both the surfaces. In order to achieve the record, it is necessary to simultaneously have access of the heads in both sides to the surface A and the surface B. Accordingly, it is efficient to employ a recording method by which the data to be recorded and reproduced is divided into both of the surfaces A and B by a unit of a certain block. Therefore, a data transfer rate becomes twice in comparison with the case of one head.

In the case that an area of the rotation stabilizing plate (a slider) is small, it is impossible to cancel the deflection of the thin optical disc. The rotation stabilizing plate having the area at least equal to or more than 4 mm² is desirable. Further, since the floating type optical head is always in parallel to the disc surface, an advantageous structure for a disc tilt is obtained.

### Embodiment 4

A recording and reproducing head mounted on the floating type slider is shown. An optical disc which is made of a polycarbonate and has a diameter of 90 mm and a thickness of 0.1 mm is mounted on the spindle, and the rotation is started. When setting the disc rotating speed to about 2000 rpm, the deflection of the disc does not appear. Two floating type optical heads are moved to an innermost peripheral head sliding position. Next, a floating amount of the floating type optical head 1 is reduced to a level at which the deflection of the substrate is not generated. The lasers of both the heads are turned on. Next, the floating amount of the floating type optical head 2 is reduced to a point at which a focus error signal of the floating type optical head 1 is largely changed. Next, the floating amount of the floating type optical head 2 is reduced to a point at which a focus error signal of the floating type optical head 2 is largely changed. The floating amounts of the floating type optical heads 1 and 2 are optimized by repeating the operations.

Next, a tracking of both the heads is executed. When the tracking is finished, both the floating type optical heads are simultaneously moved to the address positions to be recorded. Both the heads may be formed integrally or may be separated such that a fine adjustment can be executed. In general, since any displacement is generated at the positions on the surface A and the surface B to which the nano imprint is applied, or the amounts of eccentricity thereof are different, it is preferable that both the heads can be fine adjusted. Further, the structure may be made such that the tracking groove is nano imprinted only on the surface A, and the surface B is formed as a tracking free, or the structure may be inversely made.

Since the address is embedded in the optical disc at a time of nano imprinting, the recording and reproducing is started by moving both the heads. In this case, the data to be recorded is divided per some kB by a central processing unit in a structure shown in FIG. 9, and is alternately recorded in the surface A and the surface B. Taking the error correction into consideration, about 32 kB is considered to be a preferable block amount. In the case that the defect exists on the surface A, an alternation process is executed and the operation is jumped to the next surfaces A and B. In the case that a dispersion surface is allowed in a transfer rate, it is possible to record only on the surface B.

### Embodiment 5

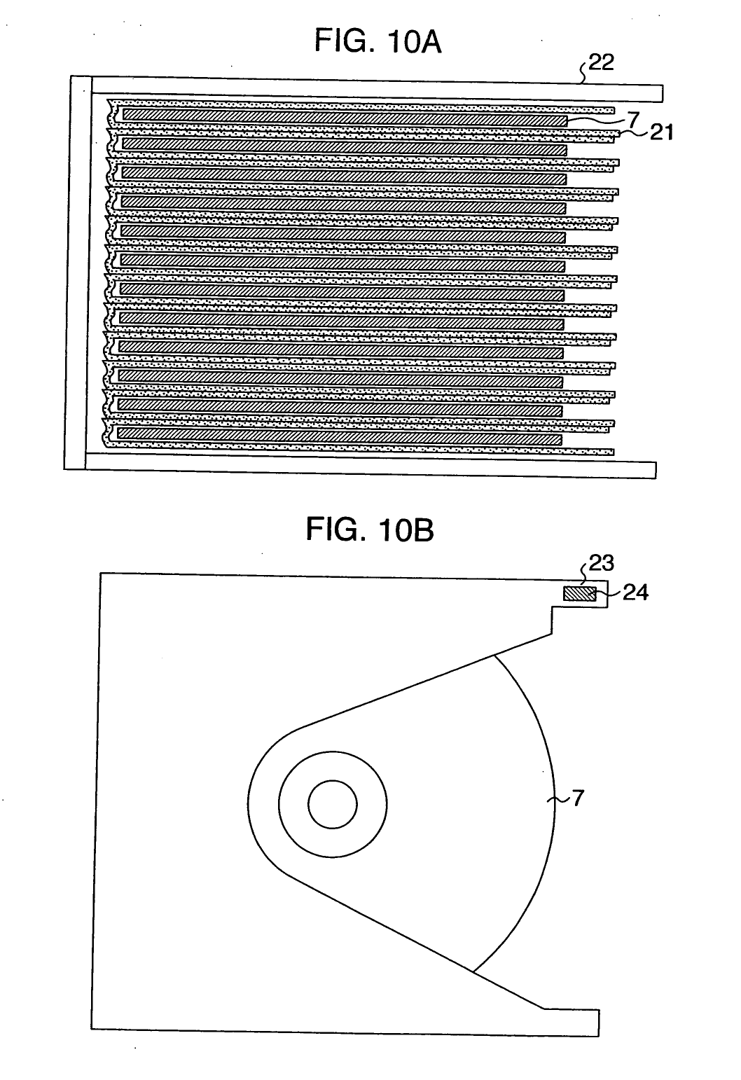

FIG. 10 shows an example in which twelve thin optical discs 7 are inserted to a cartridge 22. A disc receiving bag 21 is formed by a clean paper in which dusts are hard to be generated, and a thickness of the disc receiving bag 21 is 100 micron. In order to reduce the dust generation, an unwoven fabric can be utilized. A state in which a static electricity is hard to be charged is achieved on the basis of an antistatic treatment. A hook point 23 is formed in the disc receiving bag 21, and a strength can be increased by attaching or welding a reinforcing member around the hook point. In the case that an IC chip 24 is embedded in the reinforcing member, it is possible to check the contents of the disc by an IC reader or an IC reader writer formed in a leading end of an arm of a disc changer. If the positions of the hook points are different per the discs, it is easy to take in an out the disc.

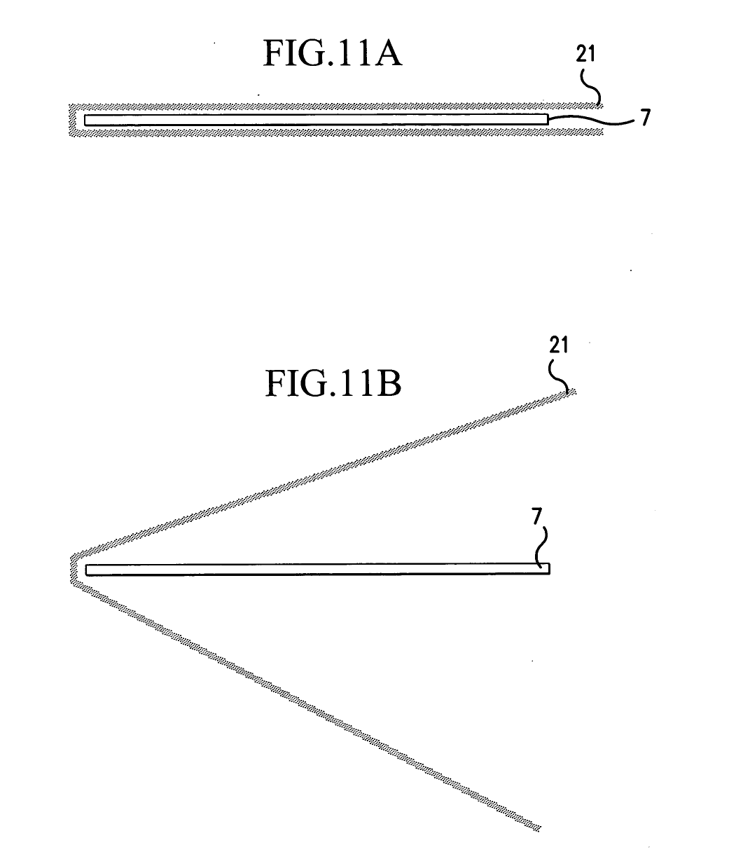

Next, a description will be given of a disc exchanging method. There is shown a case that a recording and reproducing of a disc M is finished and the disc M is replaced by a disc N. When the command of replacement is output from the central processing unit, the floating amounts of the floating type optical heads 1 and 2 are first moved upward to the initial positions, are moved to the outermost positions and are returned to the further outer head standby positions. Next, the rotation of the spindle is stopped. Since the hook portion of the disc chucking pressing portion is caught on the center hole of the disc, the disc does not come down even if the disc chucking pressing portion is moved close. Further, the disc is returned into the disc receiving bag by moving to a predetermined position Z, and the hook is detached. The returned optical disc is returned to the cartridge per the receiving bag by a robot arm. At this time, the information of the disc M is overwritten by the IC reader writer attached to the leading end of the arm. Next, the robot arm is moved to the position of the disc N, the contents of the IC memory of the disc receiving bag is read, and it is confirmed that the disc N is right set. When confirming the disc N, the disc N is taken out together with the disc receiving bag by being pinched by the robot arm, and is moved to a predetermined position. In this case, the cartridge is vertically arranged so as to be in a state in which the cartridge is hard to be robbed with the adjacent disc receiving bag. When transferring to the chucking portion, the disc center hole is held by opening the disc receiving bag 21 as shown in FIG. 11B and throwing out the hook in which the chucking pressing portion is moved close to the inner peripheral hole of the disc, and the disc is attached to the spindle motor. Thereafter, the recording and reproducing is executed by floating the floating type optical head as in the embodiment 1. The chucking may be structured as a magnet type in which a magnet is moved close from an axial direction of the spindle so as to fix.

### Embodiment 6

In the case that the flexible recording disc is received in a cartridge having a size 105 mm×105 mm×25.4 mm, about 100 sheets of discs can be received by utilizing a disc having a thickness of 0.1 mm, and a thin clean paper disc case having an antistatic treatment applied thereto and having a thickness of 0.05 and packing the discs therein in a closest manner. A total thickness of the discs and the disc receiving bags is 20 mm, and only 5.4 mm room is generated in comparison with the cartridge thickness of 25.4 mm. Accordingly, only a just room is generated for taking out any one disc. In other words, it is known that about 20% room of the total thickness is required for freely taking in and out any one disc. The floating type optical head is employed in the drive which is used for an experiment of taking out and recording and reproducing any one disc by utilizing the cartridge, a numerical aperture of the objective lens is set to 0.9, and a blue laser having a wavelength of 405 nm is employed as an optical parameter. A substrate having a track pitch of an optical disc of 0.25 nm, and a groove depth of 40 nm is manufactured in accordance with a nano imprint method. It is known that an eye is cleanly opened in an eye pattern in the case of recording an NRZI random pattern having a bit pitch of 85 nm of the disc. Since the error rate is 1×10⁻⁴, it is possible to sufficiently practicable. A data volume of one surface of the disc having a diameter of 90 mm is about 25 GB on the assumption that a format efficiency is 80%. The data volume is 50 GB per one disc, and 5 TB per one cartridge. Further, since the transfer rate is 100 Gbps per one surface at a linear velocity of 8.5 m/sec, the transfer rate is 200 Mbps per both surfaces.

1. A flexible recording disc driving method of a flexible recording disc for rotating the flexible recording disc at a high speed and recording and reproducing on the basis of a non-contact mode comprising the steps of:
rotating a standstill disc;
moving rotation stabilizing plates close to both surfaces of the disc from both sides of the disc, at a time when a rotating speed is increased and a surface vibration (a vertical vibration) of the disc is reduced;
controlling the rotating speed to a predetermined rotating speed for recording and reproducing after stabilizing the surface vibration so as to record and reproduce;
returning the rotating speed to the rotating speed at a time of moving the rotation stabilizing plates close to the disc after finishing the recording and reproducing;
moving the stabilizing plates from the disc surface; and
stopping the rotation.

2. A flexible recording disc driving method as claimed in claim 1, wherein a focus servo for avoiding a collision with a medium by using a light at a time of moving the recording and reproducing head close thereto is employed.
